(19) United States
(12) Patent Application Publication
(10) Pub. No.: US 2004/0111253 A1
(43) Pub. Date: Jun. 10, 2004

(54) System and method for rapid development of natural language understanding using active learning

(75) Inventors: Xiaoqiang Luo, Ardsley, NY (US); Salim Roukos, Scarsdale, NY (US); Min Tang, Cambridge, MA (US)

Correspondence Address: DUKE. W. YEE, CARSTENS, YEE & CAHOON,L.L.P., P.O. BOX 802334, DALLAS, TX, 75380, US

(73) Assignee: International Business Machines Corporation, Armonk, NY

(21) Appl. No.: 10/315,537

(22) Filed: Dec. 10, 2002

(51) Int. Cl. G06F 17/28

(52) U.S. Cl. 704/4

(57) ABSTRACT

A method, computer program product, and data processing system for training a statistical parser by utilizing active learning techniques to reduce the size of the corpus of human-annotated training samples (e.g., sentences) needed is disclosed. According to a preferred embodiment of the present invention, the statistical parser under training is used to compare the grammatical structure of the samples according to the parser's current level of training. The samples are then divided into clusters, with each cluster representing samples having a similar structure as ascertained by the statistical parser. Uncertainty metrics are applied to the clustered samples to select samples from each cluster that reflect uncertainty in the statistical parser's grammatical model. These selected samples may then be annotated by a human trainer for training the statistical parser.

### GOVERNMENT FUNDING

The United States Government may have certain rights to the invention disclosed and claimed herein, as the development of this invention was developed with partial support by DARPA (Defense Advanced Research Project Agency) under SPAWAR (Space Warfare) contract number N66001-99-2-8916.

### BACKGROUND OF THE INVENTION

1. Technical Field

The present invention is generally related to the application of machine learning to natural language processing (NLP). Specifically, the present invention is directed toward utilizing active learning to reduce the size of a training corpus used to train a statistical parser.

2. Description of Related Art

A prerequisite for building statistical parsers is that a corpus of parsed sentences is available. Acquiring such a corpus is expensive and time-consuming and is a major bottleneck to building a parser for a new application or domain. This is largely due to the fact that a human annotator must manually annotate the training examples (samples) with parsing information to demonstrate to the statistical parser the proper parse for a given sample.

Active learning is an area of machine learning research that is directed toward methods that actively participate in the collection of training examples. One particular type of active learning is known as “selective sampling.” In selective sampling, the learning system determines which of a set of unsupervised (i.e., unannotated) examples are the most useful ones to use in a supervised fashion (i.e., which ones should be annotated or otherwise prepared by a human teacher). Many selective sampling methods are “uncertainty based.” That means that each sample is evaluated in light of the current knowledge model in the learning system to determine a level of uncertainty in the model with respect to that sample. The samples about which the model is most uncertain are chosen to be annotated as supervised training examples. For example, in the parsing context, the sentences that the parser is less certain how to parse would be chosen as training examples

A number of researchers have applied active learning techniques, and in particular selective sampling, to the parsing of natural language sentences. C. A. Thompson, M. E. Califf, and R. J. Mooney, Active Learning for Natural Language Parsing and Information Extraction, Proceedings of the Sixteenth International Machine Learning Conference, pp. 406-414, Bled, Slovenia, June 1999, describes the use of uncertainty-based active learning to train a deterministic natural-language parser. R. Hwa, Sample Selection for Statistical Grammar Induction, Proc. 5^{th} EMNLP/VLC (Empirical Methods in Natural Language Processing/Very Large Corpora), pp. 45-52, 2000, describes a similar system for use with a statistical parser. A statistical parser is a program that uses a statistical model, rather than deterministic rules, to parse text (e.g., sentences).

These applications of active learning to natural language parsing, while they may be effective in identifying samples that are informational to the parser being trained (i.e., they effectively address uncertainties in the parsing model), they do so in a greedy way. That is, they select only the most informational samples without regard for how similar the most informational samples may be. This is somewhat of a problem because in a given set of samples, there may be many different samples that have the same structure (e.g., “The man eats the apple” has the same grammatical structure as “The cow eats the grass.”). Training on multiple samples with the same structure in this greedy fashion sacrifices the parser's breadth of knowledge for depth of training in particular weakness areas. This is troublesome in natural language parsing, as the variety of natural language sentence structures is quite large. Breadth of knowledge is essential for effective natural language parsing. Thus, a need exists for a training method that reduces the number of training examples necessary while allowing the parser to be trained on a representative sampling of examples.

### SUMMARY OF THE INVENTION

The present invention provides a method, computer program product, and data processing system for training a statistical parser by utilizing active learning techniques to reduce the size of the corpus of human-annotated training samples (e.g., sentences) needed. According to a preferred embodiment of the present invention, the statistical parser under training is used to compare the grammatical structure of the samples according to the parser's current level of training. The samples are then divided into clusters, with each cluster representing samples having a similar structure as ascertained by the statistical parser. Uncertainty metrics are applied to the clustered samples to select samples from each cluster that reflect uncertainty in the statistical parser's grammatical model. These selected samples may then be annotated by a human trainer for training the statistical parser.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram providing an external view of a data processing system in which the present invention may be implemented;

FIG. 2 is a block diagram of a data processing system in which the present invention may be implemented;

FIG. 3 is a diagram of a process of training a statistical parser as known in the art;

FIG. 4 is a diagram depicting a sequence of operations followed in performing bottom-up leftmost (BULM) parsing in accordance with a preferred embodiment of the present invention;

FIG. 5 is a diagram depicting a decision tree in accordance with a preferred embodiment of the present invention; and

FIG. 6 is a flowchart representation of a process of training a statistical parser in accordance with a preferred embodiment of the present invention.

### DETAILED DESCRIPTION OF THE PREFERRED EMBODIMENT

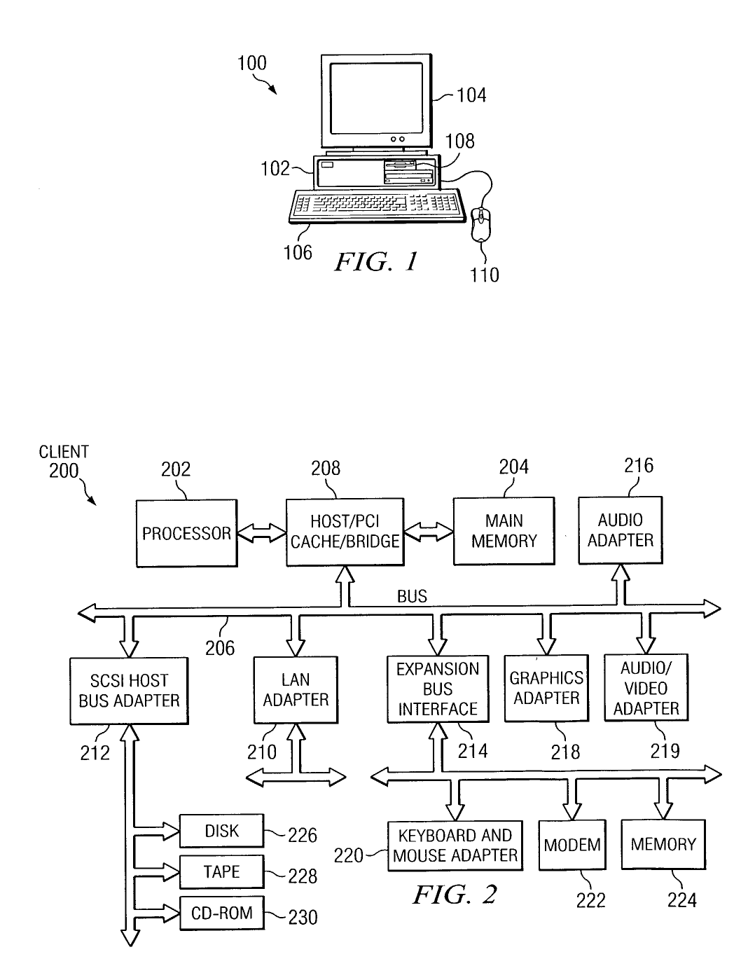

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

The present invention is directed toward training a statistical parser to parse natural language sentences. In the following paragraphs, the term “samples” will be used to denote natural language sentences used as training examples. One of ordinary skill in the art will recognize, however, that the present invention may be applied in other parsing contexts, such as programming languages or mathematical notation, without departing from the scope and spirit of the present invention.

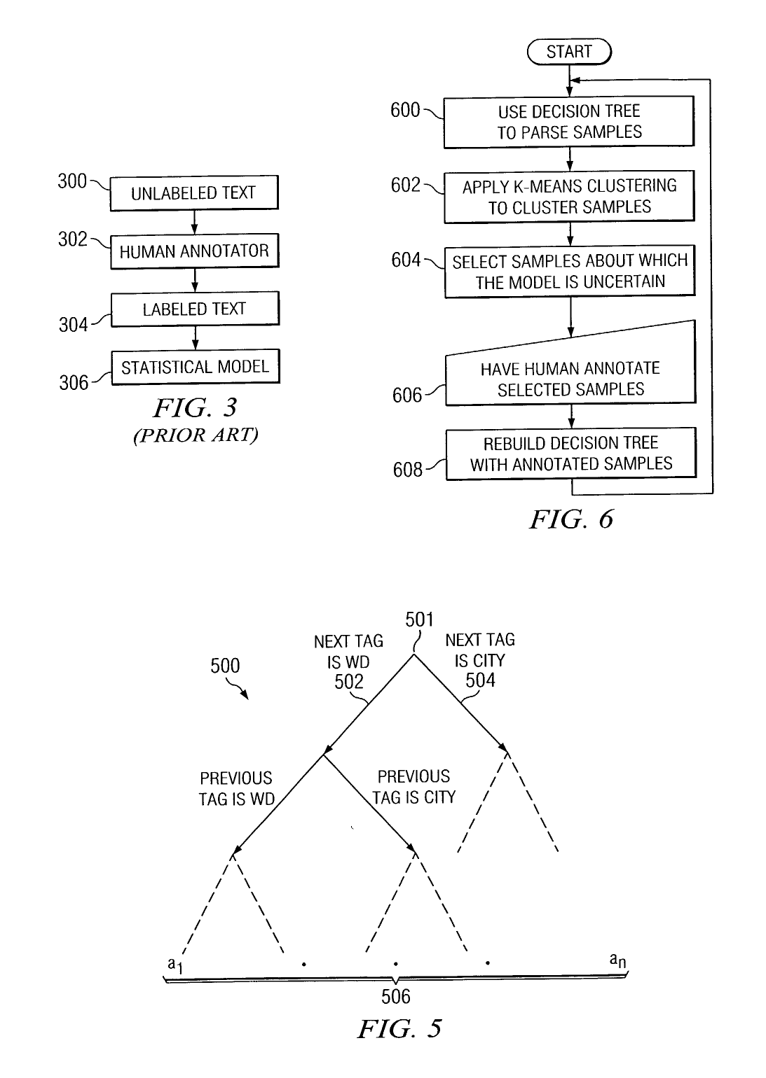

FIG. 3 is a diagram depicting a basic process of training a statistical parser as known in the art. Unlabeled or unannotated text samples 300 are annotated by a human annotator or teacher 302 to contain parsing information (i.e., annotated so as to point out the proper parse of each sample), thus obtaining labeled text 304. Labeled text 304 can then be used to train a statistical parser to develop an updated statistical parsing model 306. Statistical parsing model 306 represents the statistical model used by a statistical parser to derive a parse of a given sentence.

The present invention aims to reduce the amount of text human annotator 302 must annotate for training purposes to achieve a desirable level of parsing accuracy. A preferred embodiment of the present invention achieves this goal by 1.) representing the statistical parsing model as a decision tree, 2.) serializing parses (i.e. parse trees) in terms of the decision tree model, 3.) providing a distance metric to compare serialized parses, 4.) clustering samples according to the distance metric, and 5.) selecting relevant samples from each of the clusters. In this way, samples that contribute more information to the parsing model are favored over samples that are already somewhat reflected in the model, but a representative set of variously-structured samples is achieved. The method is described in more detail below.

Decision Tree Parser

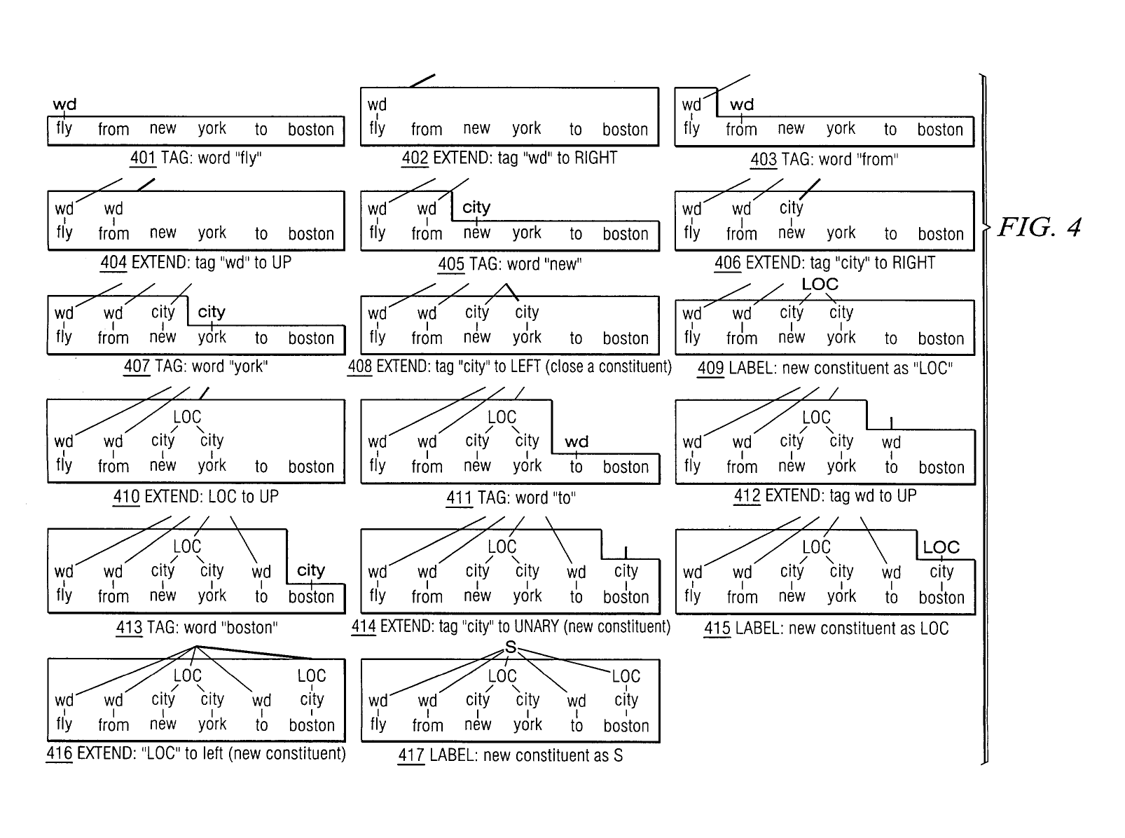

In this section, we explain how parsing can be recast as a series of decision-making process, and show that the process can be implemented using decision trees. A decision tree is a tree data structure that represents rule-based knowledge. FIG. 5 is a diagram of a decision tree in accordance with a preferred embodiment of the present invention. In FIG. 5, decision tree 500 begins at root node 501. At each node, branches (e.g., branches 502 and 504) of the tree correspond to particular conditions. To apply a decision tree to a particular problem, the tree is traversed from root node 501, following branches for which the conditions are true until a leaf node (e.g., leaf nodes 506) is reached. The leaf node reached represents the result of the decision tree. For example, in FIG. 5, leaf nodes 506 represent different possible parsing actions in a bottom up leftmost parser taken in response to conditions represented by the branches of decision tree 500. Note that in a decision tree parser, such as is employed in the present invention, the decision tree represents the rules to be applied when parsing text (i.e., it represents knowledge about how to parse text). The resulting parsed text is also placed in a tree form (e.g., FIG. 4, reference number 417). The tree that results from parsing is called a parse tree.

Our goal in building a statistical parser is to build a conditional model P(T|S), the probability of a parse tree T given the sentence s. As will be shown shortly, a parse tree T can be represented by an ordered sequence of parsing actions a₁, a₂, . . . , aₙ_{_{T}}. So the model P(T|S) can be decomposed as

$$\begin{matrix}P ( T \vert S ) = P ( {a}_{1} , {a}_{2} , … , {a}_{{n}_{T}} \vert S ) \\ = {\prod }_{i = 1}^{{n}_{T}} P ( {a}_{i} \vert S , {a}_{1}^{( i - 1 )} ) ,\end{matrix} \qquad ( 1 )$$

where a₁⁽ⁱ⁻¹⁾=a₁, a₂, . . . , aᵢ₋₁. This shows that the problem of parsing can be recast as predicting next action aᵢ given the input sentence S and proceeding actions a₁⁽ⁱ⁻¹⁾.

There are many ways to convert a parse tree T into a unique sequence of actions. We will detail a particular derivation order, bottom-up leftmost (BULM) derivation, which may be utilized in a preferred embodiment of the present invention.

BULM Serialization of Parse Trees

In a preferred embodiment of the present invention there are three recognized parsing actions: tagging, labeling and extending. Other parsing actions may be included as well without departing from the scope and spirit of the present invention. Tagging is assigning tags (or pre-terminal labels) to input words. Without confusion, non-preterminal labels are simply called “labels.” A child node and a parent node are related by four possible extensions: if a child node is the only node under a label, we say the child node is said to extend “UNIQUE” to the parent node; if there are multiple children under a parent node, the left-most child is said to extend “RIGHT” to the parent node, the right-most child node is said to extend “LEFT” to the parent node, while all the other intermediate children are said to extend “UP” to the parent node. In other words, there are four kinds of extensions: RIGHT, LEFT, UP and UNIQUE. All these can be best explained with the help of an example illustrated in FIG. 4.

The input sentence is fly from new york to boston and its shallow semantic parse tree is the subfigure 417. Let us assume that the parse tree is known (this is the case at training), the bottom-up leftmost (BULM) derivation works as follows:

1. tag the first word fly with the tag wd (subfigure 401);

2. extend the tag wd RIGHT, as the tag wd is the left-most child of the constituent S (subfigure 402);

3. tag the second word from with the tag wd (subfigure 403);

4. extend the tag wd UP, as the current tag wd is neither left-most not right-most child (subfigure 404);

5. tag the third word new with the tag city (subfigure 405);

6. extend the tag city RIGHT, as the tag city is the left-most child of the constituent LOC (subfigure 406);

7. tag the forth word york with the tag city (subfigure 407);

8. extend the tag city LEFT, as the tag city is the right-most child of the constituent LOC. Note that extending LEFT a node means that a new constituent is created (subfigure 408);

9. label the newly created constituent with the label “LOC” (subfigure 409);

10. extend the label “LOC” UP, as it is one of the middle child of S (subfigure 410);

11. tag the fifth word to with the tag wd (subfigure 411);

12. extend the tag wd UP, as it is a middle node (subfigure 412);

13. tag the sixth word boston with the tag city (subfigure 413);

14. extend the tag city UNIQUE, as it is the only child under “LOC.” A UNIQUE extension creates a new node (subfigure 414);

15. label the node as “LOC” (subfigure 415);

16. extend the node “LOC” LEFT, which closes all pending RIGHT and UP extensions and creates a new node (subfigure 416);

17. label the node as “S.” (subfigure 417).

It is clear, then, that the BULM derivation converts a parse tree into a unique sequence of parsing actions, and vice versa. Therefore, a parse tree can be equivalently represented by the sequence of parsing actions.

Let τ(S) be the set of tagging actions, L(S) be the labeling actions and E(S) be the extending actions of S, and let h(a) be the sequence of actions ahead of the action a, then equation (1) above can be rewritten as:

$$\begin{matrix}P ( T \vert S ) = {\prod }_{i = 1}^{{n}_{T}} P ( {a}_{i} \vert S , {a}_{1}^{( i - 1 )} ) \\ = {\prod }_{a ∈ τ ( S )}^{} P ( a \vert S , h ( a ) ) {\prod }_{b ∈ L ( S )}^{} P ( b \vert S , h ( b ) ) {\prod }_{c ∈ E ( S )}^{} P ( c \vert S , h ( c ) ) .\end{matrix}$$

Note that |τ(S)|+|L(S)|+|E(S)|=n_{T}. This shows that there are three models: a tag model, a label model and an extension model. The problem of parsing has now reduced to estimating the three probabilities. And the procedure for building a parser is clear:

annotate training data to get parse trees;

use the BULM derivation to navigate parse trees and record every event, i.e., a parse action a with its context (S, h(a)), and the count of each event C((S, h(a)), a);

estimate the probability P(a|S, h(a)), a being either a tag, a label or an extension, as:

$$P ( a \vert S , h ( a ) ) = \frac{C ( ( S , h ( a ) ) , a )}{{\sum }_{x} C ( ( S , h ( a ) ) , x )} , \qquad ( 2 )$$

where x sums over either the tag, or the label, or the extension vocabulary, depending on whether P(a|S, h(a)) is the tag, label or extension model.

The problem with this straightforward estimate is that the space of (S, h(a)) is so large that most of C((S, h(a)), a) will be zeroes, and the resulted model will be too fragile to be useful. It is therefore necessary to pool statistics, and in our parser, decision trees are employed to achieve this goal. There is a set of pre-designed questions Q={q₁, q₂, . . . , q_{N}} which are applied to the context (S, h(a)), and events whose contexts give the same answer are pooled together. Or formally, let Q(S, h(a)) be the answers when applying each question in Q to the context (S, h(a)), equation (2) above can now be revised as:

$$P ( a \vert S , h ( a ) ) = \frac{{\sum }_{( {S}^{′} , {h}^{′} ) \text{:} Q ( {S}^{′} , {h}^{′} ) = Q ( S , h ( a ) )} C ( ( {S}^{′} , {h}^{′} ) , a )}{{\sum }_{( {S}^{′} , {h}^{′} ) \text{:} Q ( {S}^{′} , {h}^{′} ) = Q ( S , h ( a ) )} {\sum }_{x} C ( ( {S}^{′} , {h}^{′} ) , x )} ,$$

That is, the probability at a decision tree leaf is estimated by counting all events falling into that leaf. In practice, a smoothing function can be applied to the probabilities to make the model more robust.

Bitstring Representation of Contexts

When building decision trees, it is necessary to store events, or contexts and parsing actions. As shown in FIG. 4, raw contexts (constructs enclosed in dashed-lines) take all kinds of shapes, and a practical issue is how to store these contexts so that events can be manipulated efficiently. In our implementation, contexts are internally represented as bitstrings, as described below.

For each question qᵢ, there is an answer vocabulary, each of which is represented as a bitstring. Word, tag, label and extension vocabularies have to be encoded so that questions like “what is the previous word?”, or “what is the previous tag?”, can be asked. Bitstring encoding of words can be performed in a preferred embodiment using a word-clustering algorithm described in P. F. Brown, V. J. Della Pietra, P. V. deSouza, J. C. Lai, and R. L. Mercer, “Class-based n-gram models of natural language,” Computational Linguistics, 18: 467-480, 1992, which is hereby incorporated by reference. Tags, labels and extensions are encoded using diagonal bits. Let us use again the example in FIG. 4 to show how this works.

TABLE 1
Encoding of Vocabularies

| Word | Encoding | Tag | Encoding | Label | Encoding |
|---|---|---|---|---|---|
| fly | 1000 | wd | 100 | LOC | 10 |
| from | 1001 | city | 010 | S | 01 |
| new | 1100 | NA | 001 | NA | 00 |
| york | 0100 | | | | |
| to | 1001 | | | | |
| boston | 0100 | | | | |
| NA | 0010 | | | | |

Let word, tag, label and extension vocabularies be encoded as in Table 1, and let the question set be:

q₁: what is the current word?

q₂: what is the previous tag?

q₃: Is the current word one of the city words (boston, new, york)?

q₄: what is the previous label?

where the current word is the right-most word in the current sub-tree, the previous tag is the tag on the right-most word of the previous sub-tree, and the previous label is the top-most label of the previous sub-tree. Note that there is a special entry “NA” in each vocabulary. It is used when the answer to a question is “not-applicable.” For instance, the answer to q₂ when tagging the first word fly is “NA.” Applying the four questions to contexts of 17 events in FIG. 4, we get the bitstring representation of these events shown in Table 2. For example, when applying q₁ to the first event, the answer will be the bitstring representation of the word fly, which is 1000; the answer to q₂, “what is the previous tag?” is “NA”, therefore 001; Since fly is not one of the city words {new, york, boston}, the answer to q₃ is 0; The answer to q₄ is “NA”, so 00. The context representation for the first event is obtained by concatenating the four answers: 100000100.

TABLE 2
Bitstring Representation of Contexts

| Answer to | | | | | |
|---|---|---|---|---|---|
| Event | | | | | |
| No. | q₁ | q₂ | q₃ | q₄ | Parse ACTION |
| 1 | 1000 | 001 | 0 | 00 | tag: wd |
| 2 | 1000 | 001 | 0 | 00 | extend: RIGHT |
| 3 | 1001 | 100 | 0 | 00 | tag: wd |
| 4 | 1001 | 100 | 0 | 00 | extend: UP |
| 5 | 1100 | 100 | 1 | 00 | tag: city |
| 6 | 1100 | 100 | 1 | 00 | extend: RIGHT |
| 7 | 0100 | 010 | 1 | 00 | tag: city |
| 8 | 0100 | 010 | 1 | 00 | extend: LEFT |
| 9 | 0100 | 010 | 1 | 00 | label: LOC |
| 10 | 0100 | 100 | 1 | 00 | extend: UP |
| 11 | 1001 | 010 | 0 | 10 | tag: wd |
| 12 | 1001 | 010 | 0 | 10 | extend: UP |
| 13 | 0100 | 100 | 1 | 00 | tag: city |
| 14 | 0100 | 100 | 1 | 00 | extend: UNARY |
| 15 | 0100 | 100 | 1 | 00 | label: LOC |
| 16 | 0100 | 100 | 1 | 00 | extend: LEFT |
| 17 | 0100 | 001 | 1 | 00 | label: S |

Bitstring representation of contexts provides us with two major advantages: first, it renders a uniform representation of contexts; Second, bitstring representation offers a natural way to measure the similarity between two contexts. The latter is an important capability facilitating the clustering of sentences.

It has been shown that a parse tree can be equivalently represented by a sequence of events and each event can in turn be represented by a bitstring, we are now ready to define a distance for sentence clustering.

Model-Based Sentence Clustering

When selecting sentences for annotating, we have two goals in mind: first, we want the selected samples to be “representative” in the sense that the sample represent the broad range of sentence structures in the training set. Second, we want to select those sentences which the existing model parses poorly. We will develop clustering algorithms so that sentences are first classified, and then representative sentences are selected from each cluster. The second problem is a matter of uncertainty measure and will be addressed in a later section.

To cluster sentences, we first need to a distance or similarity measure. The distance measure should have the property that two sentences with similar structures have a small distance, even if they are lexically quite different. This leads us to define the distance between two sentences based on their parse trees. The problem is that true parse trees are, of course, not available at the time of sample selection. This problem can be dealt with, however, as elaborated below.

Sentence Distance

The parse trees generated by decoding two sentences S₁ and S₂ with the current model M are used as approximations of the true parses. To emphasize the dependency on M, we denote the distance between the parse trees of sentences S₁ and S₂ as d_{M}(S₁, S₂). Further, the distance defined between the parse trees satisfies the requirement that the distance reflects the structural difference between sentences. Thus, we will use the decoded parse trees T₁ and T₂ while computing d_{M}(S₁, S₂), and write in turn the distance as d_{M}((S₁, T₁), (S₂, T₂)). It is not a concern that T₁ and T₂ are not true parses. The reason is that here we are seeking a distance relative to the existing model M, and it is a reasonable assumption that if M produces similar parse trees for two sentences, then the two sentences are likely to have similar “true” parse trees.

We have shown previously that a parse tree can be represented by a sequence of events, that is, a sequence of parsing actions together with their contexts. Let Eᵢ=eᵢ⁽¹⁾, eᵢ⁽²⁾, . . . , eᵢ^{(L}^{ᵢ}⁾ be the sequence representation for (Sᵢ, Tᵢ) (i=1, 2), where eᵢ^{j}=(hᵢ^{(j)}, aᵢ^{(j)}), and hᵢ^{(j)} is the context and aᵢ^{(j)} is the parsing action of the j^{th} event of the parse tree Tᵢ. Now we can define the distance between two sentences S₁, S₂ as

$$\begin{matrix}{d}_{M} ( {S}_{1} , {S}_{2} ) = {d}_{M} ( ( {S}_{1} , {T}_{1} ) , ( {S}_{2} , {T}_{2} ) ) \\ = {d}_{M} ( {E}_{1} , {E}_{2} )\end{matrix}$$

The distance between two sequences E₁ and E₂ is computed as the editing distance. It remains to define the distance between two individual events.

Recall that it has been shown that contexts {hᵢ^{(j)}} can be encoded as bitstrings. It is natural to define the distance between two contexts as Hamming distance between their bitstring representations. We further define the distance between two parsing actions: it is either 0 (zero) or a constant c if they are the same type (recall there are three types of parsing actions: tag, label and extension), and infinity if different types. We choose c to be the number of bits in hᵢ^{(j)} to emphasize the importance of parsing actions in distance computation. Formally,

d(e₁^{(j)}, e₂^{(k)})=H(h₁^{(j)}, h₂^{(k)})+d(a₁^{(j)}, a₂^{(k)}),

where H(h₁^{(j)}, h₂^{(k)}) is the Hamming distance, and

$$d ( {a}_{1}^{( j )} , {a}_{2}^{( k )} ) = \{ \begin{matrix}0 & if {a}_{1}^{( j )} = {a}_{2}^{( k )} \\ c & if type ( {a}_{1}^{( j )} ) = type ( {a}_{2}^{( k )} ) and {a}_{2}^{( j )} \\ ∞ & if type ( {a}_{1}^{j} ) \neq type ( {a}_{2}^{( k )} ) .\end{matrix} {a}_{2}^{( k )}$$

In a preferred embodiment, the editing distance may be calculated via dynamic programming (i.e., storing previously calculated solutions to subproblems to use in subsequent calculations). This reduces the computational workload of calculating multiple editing distances. Even with dynamic progamming, however, when the algorithm is applied in a naive fashion, the editing distance algorithm is computationally intensive. To speed up computation, we can choose to ignore the difference in contexts, or in other words, becomes

$$\begin{matrix}d ( {e}_{1}^{( j )} , {e}_{2}^{( k )} ) = H ( {h}_{1}^{( j )} , {h}_{2}^{( k )} ) + d ( {a}_{1}^{( j )} , {a}_{2}^{( k )} ) \\ \approx d ( {a}_{1}^{( j )} , {a}_{2}^{( k )} ) .\end{matrix}$$

We will refer to this metric as the simplified distance metric.

Sample Density

The distance d_{M}(.,.) makes it possible to characterize how dense a sentence is. Given a set of sentences S=S₁, . . . , S_{N}, the density of sample Sᵢ is:

$$ρ ( {S}_{i} ) = \frac{N - 1}{{\sum }_{j \neq i} {d}_{M} ( {S}_{j} , {S}_{i} )}$$

That is, the sample density is defined as the inverse of its average distance to other samples.

We have defined a model-based distance between sentences using bitstring representation of parse trees. However, we have not defined a coordinate system to describe the sample space. The bitstring representation in itself can not be considered as coordinates as, for example, the length of bitstrings varies for different sentences. To realize this difference is important when designing the clustering algorithm.

In most clustering algorithms, there is a step of calculating the cluster center or centroid (also referred to as “center of gravity”), as in K-means clustering, for example. We define the sample that achieves the highest density as the centroid of the cluster. Given a cluster of sentences S={S₁, . . . , S_{N}}, the centroid π_{S} of the cluster is defined as:

$${π}_{S} = {arg max}_{{S}_{i}} ( ρ ( {S}_{i} ) )$$

K-Means Clustering

With the model-based distance measure described above, it is straightforward to use the k-means clustering algorithm to cluster sentences. The K-means clustering algorithm is described in Frederick Jelinek, Statistical Methods for Speech Recognition, MIT Press, 1997, p. 11, which is hereby incorporated by reference. A sketch of the algorithm is provided here. Let S={S₁, S₂, . . . , S_{N}} be the set of sentences to be clustered. The algorithm proceeds as follows:

Initialization. Partition {S₁, S₂, . . . , S_{N}} into k initial clusters [symbol] ⱼ⁰ (j=1, . t=0.

Find the centroid πⱼ^{t} for each cluster [symbol] ⱼ^{t}, that is:

$${π}_{j}^{t} = {arg min}_{π ∈ {j}_{t}^{}} {\sum }_{{S}_{i} ∈ {j}_{t}^{}} {d}_{M} ( {S}_{i} , π )$$

Re-partition {S₁, S₂, . . . , S_{N}} into k clusters [symbol] ⱼ^{t+1} (j=1, . . . , k), where

[symbol]

ⱼ^{t+1}={Sᵢ: d_{M}(Sᵢ, πⱼ^{t})≦d_{M}(Sᵢ, πⱼ^{t}),

Let t=t+1. Repeat Step 2 and Step 3 until the algorithm converges (e.g., relative change of the total distortion is smaller than a threshold, with “total distortion” being defined as Σⱼ Σ_{S}_{ᵢ}_{ε} [symbol] _{ⱼ} d_{M}(Sᵢ, πⱼ)).

Finding the centroid of each cluster is equivalent to finding the sample with the highest density, as defined in denseq.

At each iteration, the distance between samples Sᵢ and cluster centroids πⱼ^{t} and the pair-wise distances within each cluster must be calculated. The basic operation underlying these two calculations is to calculate the distance between two sentences, which is time-consuming, even when dynamic programming is utilized.

To speed up the process, a preferred embodiment of the present invention maintains an indexed list (i.e., a table) of all the distances computed. When the distance between two sentences is needed, the table is consulted first and the dynamic programming routine is called only when no solution is available in the table. This execution scheme is referred to as “tabled execution,” particularly in the logic programming community. Execution can be further sped up by using representative sentences and an initialization process, as described below.

Representative Sentences

Even when a large corpus of training samples is used, the actual number of unique parse trees is much smaller. If the distance between two sentences S₁ and S₂ is zero:

d_{M}(S₁, S₂)=0

we know that their parse trees must be the same (although the contexts may be different). If the simplified distance metric is used, the two corresponding event sequences are equivalent:

E₁≡E₂.

Hence, for any sentence Sᵢ,

d_{M}(S₁, Sᵢ)≡d_{M}(S₂, Sᵢ)

will be true.

We can then use only one sentence to represent all sentences that have zero distance from that one sentence. A count of “identical sentences” corresponding to a given representative sentence is necessary for the clustering algorithm to work properly. We denote the representative-count pairs as (S′ᵢ, Cᵢ). Now the density of a representative sentence in a cluster [symbol] becomes:

$$ρ ( {S}_{2}^{′} ) = \frac{{\sum }_{k = 1}^{n} {C}_{k} - 1}{{\sum }_{{S}_{3}^{′} ∈}^{} {C}_{3} {d}_{M} ( {S}_{j}^{′} , {S}_{2}^{′} )}$$

Using representative sentences can greatly reduce computation load and memory demand. For example, experiments conducted with a corpus of around 20,000 sentences resulted in only about 1,000 unique parse trees.

Bottom-Up Initialization

In a preferred embodiment, bottom-up initialization is employed to “pre-cluster” the samples and place them closer to their final clustering positions before the k-means algorithm begins. The initialization starts by using each representative sentence as a single cluster. The initialization greedily merges the two clusters that are the most “similar” until the expected number of “seed” clusters for k-means clustering are reached. The initialization process proceeds as follows:

For n clusters [symbol] ᵢ where i=1, 2, . . . , n;

Find the centroid πᵢ for each cluster.

Find the two clusters [symbol] ₗ and [symbol] ₘ that minimize

$$\frac{\vert {l}_{} \vert \cdot \vert {m}_{} \vert \cdot {d}_{M} ( {π}_{3} , {π}_{m} )}{\vert {l}_{} \vert + \vert {m}_{} \vert} .$$

Merge clusters [symbol] ₗ and [symbol] ₘ into one cluster.

Repeat until the total number of clusters is the number desired

Uncertainty Measures

Once a set of clusters has been established (e.g., via k-means clustering), samples from each cluster about which the current statistical parsing model is uncertain are determined via one or more uncertainty measures. The model may be uncertain about a sample because the model is under-trained or because the sample itself is difficult. In either case, it makes sense to select the samples that the model is uncertain (neglecting the sample density for the moment).

Change of Entropy

If the parsing model is represented in the form of decision trees, after the decision trees are grown, the information-theoretic entropy of each leaf node l in a given tree can be calculated as:

$${H}_{l} = - {\sum }_{i}^{} {p}_{l} ( i ) log {p}_{l} ( i ) ,$$

where i sums over the tag, label, or extension vocabulary (i.e., the i's represent each element of one of the vocabularies), and pₗ(i) is defined as

$$\frac{{N}_{l} ( i )}{{\sum }_{l}^{} {N}_{l} ( j )} ,$$

where Nₗ(i) is the count ofi in leaf node l. In other words, for a given leaf node l, Nₗ(i) represents the number of times in the training set in which the tag or label i is assigned to the context of leaf node l (the context being the particular set of answers to the decision tree questions that result in reaching leaf node l). The model entropy H is the weighted sum of Hₗ:

$$H = {\sum }_{l}^{} {N}_{l} {H}_{l} ,$$

where Nₗ=Σₗ Nₗ(i). It can be verified that −H is the log probability of training events. After seeing an unlabeled sentence S, S may be decoded using the existing model to obtain its most probable parse T. The tree T can then be represented by a sequence of events, which can be “poured” down the grown trees, and the count Nₗ(i) can be updated accordingly to obtain an updated count N′ₗ(i). A new model entropy H′ can be computed based on N′ₗ(i), and the absolute difference, after being normalized by the number of events n_{T} in T (the “number of events” in T being the number of operations needed to construct T with BULM derivation—for example, the number of events in the tree found in FIG. 4 is 17), is the change of entropy value H_{Δ} defined as:

$${H}_{Δ} = \frac{\vert {H}^{′} - H \vert}{{n}_{T}} .$$

It is worth pointing out that H_{Δ} is a “local” quantity in that the vast majority of N′ₗ(i) are equal to their corresponding Nₗ(i), and thus only leaf nodes where counts change need be considered when calculating H_{Δ}. In other words, H_{Δ} can be computed efficiently. H_{Δ} characterizes how a sentence S “surprises” the existing model: if the addition of events due to S changes many pₗ(.) values and, consequently, changes H, the sentence is probably not well represented in the initial training set and H_{Δ} will be large. Those sentences are those which should be annotated.

Sentence Entropy

Sentence entropy is another measurement that seeks to address the intrinsic difficulty of a sentence. Intuitively, we can consider a sentence more difficult if there are potentially more parses. Sentence entropy is the entropy of the distribution over all candidate parses and is defined as follows:

Given a sentence S, the existing model M could generate the K most likely parses {Tᵢ: i=1, 2, . . . , K}, each Tᵢ having a probability qᵢ:

M: S→(Tᵢ, qᵢ)|ᵢ₌₁^{K}

where Tᵢ is the i^{th} possible parse and qᵢ its associated score. Without confusion, we drop qᵢ's explicit dependency on M and define the sentence entropy as:

$$\begin{matrix}{H}_{S} = {\sum }_{i = 1}^{K} - {p}_{i} log {p}_{i} \\ where : \\ {p}_{i} = \frac{{q}_{i}}{{\sum }_{j = 1}^{K} {q}_{j}} .\end{matrix}$$

Word Entropy

As one can imagine, a long sentence tends to have more possible parsing results not becuase it is necessarily difficult, but simply because it is long. To counter this effect, the sentence entropy can be normalized by sentence length to calculate the per-word entropy of a sentence:

$${H}_{ω} = \frac{{II}_{s}}{{L}_{S}}$$

where Lₛ is the number of words in s.

Sample Selection

Designing a sample selection algorithm involves finding a balance between the density distribution and information distribution in the sample space. Though sample density has been derived in a model-based fashion, the distribution of samples is model-independent because which samples are more likely to appear is a domain-related property. The information distribution, on the other hand, is model-dependent because what information is useful is directly related to the task, and hence, the model.

For a fixed batch size B, the sample selection problem is to find from the active training set of samples a subset of size B that is most helpful to improving parsing accuracy. Since an analytic formula for a change in accuracy is not available, the utility of a given subset can only be approximated by quantities derived from clusters and uncertainty scores.

In a preferred embodiment of the present invention, the sample selection method should consider both the distribution of sample density and the distribution of uncertainty. In other words, the selected samples should be both informative and representative. Two sample selection methods that may be used in a preferred embodiment of the present invention are described here. In both methods, the sample space is divided into B sub-spaces and one or more samples are selected from each sub-space. The two methods differ in the way the sample space is divided and samples selected.

Maximum Uncertainty Method

The maximum uncertainty method involves selcting the most “informative” sample out of each cluster. The clustering step guarantees the representativeness of the selected samples. According to a preferred embodiment, the maximum uncertainty method proceeds by running a k-means clustering algorithm on the active training set. The number of clusters then becomes the batch size B. From each cluster, the sample having the highest uncertainty score is chosen. In one variation on the basic maximum uncertainty method, the top “n” samples in terms of uncertainty score are chosen, with “n” being some pre-determined number.

Equal Uncertainty Method

The equal information distribution method divides the sample space in such a way that useful information is distributed as uniformly among the clusters as possible. A greedy algorithm for bottom-up clustering is to merge two clusters that minimize cumulative distortion at each step. This process can be imagined as growing a “clustering tree” by repeatedly greedily merging two clusters together such that the merger of the two clusters chosen results in the smallest change in total distortion and repeating this merging process until a single cluster is obtained. A clustering tree is thus obtained, where the root node of the tree is the single resulting cluster, the leaf nodes are the original set of clusters, and each internal node represents a cluster obtained by merger.

Once the entire tree is grown, a cut of the tree is found in which the uncertainty is uniformly distributed and the size of the cut equals the batch size. This can be done algorithmically by starting at the root node, traversing the tree top-down, and replacing the non-leaf node exhibiting the greatest distortion with its two children until the desired batch size is reached. The cut then defines a new clustering of the active training set. The centroid of each cluster then becomes a selected sample.

Weighting Samples

The active learning techniques described above with regard to selecting samples may also be employed to apply weights to samples. Weighting samples allows the learning algorithm employed to update the statistical parsing model to assess the relative importance of each sample. Two weighting schemes that may be employed in a preferred embodiment of the present invention are described below.

Weight by Density

A sample with higher density should be assigned a greater weight, because the model can benefit more by learning from this sample as it has more neighbors. Since the density of a sample is calculated inside of its cluster, the density should be adjusted by the cluster size to avoid an unwanted bias toward smaller clusters. For example, for a cluster [symbol] ={Sᵢ}|ᵢ₌₁ⁿ, the weight for sample Sₖ may be proportional to | [symbol] |·p(Sₖ).

Weight by Performance

Another approach is to assign weights according to the failure of the current statistical parsing model to determine the proper parse of known examples (i.e., samples from the active training set). Those samples that are incorrectly parsed by the current model are given higher weight.

1.1 Summary Flowchart

FIG. 6 is a flowchart representation of a process of training a statistical parser in accordance with a preferred embodiment of the present invention. First, a decision tree parsing model is used to parse a collection of unannotated text samples (block 600). A clustering algorithm, such as k-means clustering, is applied to the parsed text samples to partition the samples into clusters of similarly structured samples (block 602). Samples about which the parsing model is uncertain are chosen from each of the clusters (block 604). These samples are submitted to a human annotator, who annotates the samples with parsing information for supervised learning (block 606). Finally, the parsing model, preferably represented by a decision tree, is further developed using the annotated samples as training examples (block 608). The process then cycles to step 600 for continuous training.

It is important to note that while the present invention has been described in the context of a fully functioning data processing system, those of ordinary skill in the art will appreciate that the processes of the present invention are capable of being distributed in the form of a computer readable medium of instructions or other functional descriptive material and in a variety of other forms and that the present invention is equally applicable regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system. Functional descriptive material is information that imparts functionality to a machine. Functional descriptive material includes, but is not limited to, computer programs, instructions, rules, facts, definitions of computable functions, objects, and data structures.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system comprising:
parsing with a parsing model a plurality of samples from a training set to obtain parses of each of the plurality of samples;
dividing the plurality of samples into clusters such that each cluster contains samples having similar parses;
selecting at least one sample from each of the clusters for human annotation; and
updating the parsing model with the annotated at least one sample from each of the clusters.

2. The method of claim 1, wherein dividing the plurality of samples into clusters further comprises:
dividing the plurality of samples into an initial set of clusters;
serializing each of the parses;
computing a centroid for each cluster in the initial set of clusters to obtain a plurality of centroids;
computing a distance metric between each of the plurality of samples and each of the centroids; and
repartitioning the plurality of samples so that each sample is placed in the cluster the centroid of which has the lowest distance metric with respect to that sample.

3. The method of claim 1, wherein dividing the plurality of samples into clusters further comprises:
dividing the plurality of samples into an initial set of clusters;
calculating a similarity measure between each pair of clusters in the set of clusters; and
repeatedly combining in a greedy fashion the pair of clusters in the set of clusters that are the most similar according to the similarity measure.

4. The method of claim 1, further comprising:
computing pairwise distance metrics for each pair of samples in the plurality of samples;
dividing the plurality of samples into groups, wherein each sample in each of the groups has a zero distance metric with respect to other samples in the same group; and
replacing each of the groups with a representative sentence from that group.

5. The method of claim 1, wherein the at least one sample is selected on the basis of the at least one sample maximizing an uncertainty measure, wherein the uncertainty measure represents a degree of uncertainty in the parsing model as applied to the at least one sample.

6. The method of claim 5, wherein the uncertainty measure is a change in entropy of the parsing model.

7. The method of claim 6, wherein the plurality of samples include sentences and the change in entropy is normalized with respect to sentence length.

8. The method of claim 5, wherein the uncertainty measure is sentence entropy.

9. The method of claim 8, wherein the plurality of samples include sentences and the sentence entropy is normalized with respect to sentence length.

10. The method of claim 1, wherein the parsing model is represented as a decision tree.

11. A computer program product in a computer-readable medium comprising functional descriptive material that, when executed by a computer, enables the computer to perform acts including:
parsing with a parsing model a plurality of samples from a training set to obtain parses of each of the plurality of samples;
dividing the plurality of samples into clusters such that each cluster contains samples having similar parses;
selecting at least one sample from each of the clusters for human annotation; and
updating the parsing model with the annotated at least one sample from each of the clusters.

12. The computer program product of claim 11, wherein dividing the plurality of samples into clusters further comprises:
dividing the plurality of samples into an initial set of clusters;
serializing each of the parses;
computing a centroid for each cluster in the initial set of clusters to obtain a plurality of centroids;
computing a distance metric between each of the plurality of samples and each of the centroids; and
repartitioning the plurality of samples so that each sample is placed in the cluster the centroid of which has the lowest distance metric with respect to that sample.

13. The computer program product of claim 11, wherein dividing the plurality of samples into clusters further comprises:
dividing the plurality of samples into an initial set of clusters;
calculating a similarity measure between each pair of clusters in the set of clusters; and
repeatedly combining in a greedy fashion the pair of clusters in the set of clusters that are the most similar according to the similarity measure.

14. The computer program product of claim 11, comprising additional functional descriptive material that, when executed by the computer, enables the computer to perform additional acts including:
computing pairwise distance metrics for each pair of samples in the plurality of samples;
dividing the plurality of samples into groups, wherein each sample in each of the groups has a zero distance metric with respect to other samples in the same group; and
replacing each of the groups with a representative sentence from that group.

15. The computer program product of claim 11, wherein the at least one sample is selected on the basis of the at least one sample maximizing an uncertainty measure, wherein the uncertainty measure represents a degree of uncertainty in the parsing model as applied to the at least one sample.

16. The computer program product of claim 15, wherein the uncertainty measure is a change in entropy of the parsing model.

17. The computer program product of claim 16, wherein the plurality of samples include sentences and the change in entropy is normalized with respect to sentence length.

18. The computer program product of claim 15, wherein the uncertainty measure is sentence entropy.

19. The computer program product of claim 18, wherein the plurality of samples include sentences and the sentence entropy is normalized with respect to sentence length.

20. The computer program product of claim 11, wherein the parsing model is represented as a decision tree.

21. A data processing system comprising:
means for parsing with a parsing model a plurality of samples from a training set to obtain parses of each of the plurality of samples;
means for dividing the plurality of samples into clusters such that each cluster contains samples having similar parses;
means for selecting at least one sample from each of the clusters for human annotation; and
means for updating the parsing model with the annotated at least one sample from each of the clusters.

22. The data processing system of claim 21, wherein dividing the plurality of samples into clusters further comprises:
dividing the plurality of samples into an initial set of clusters;
serializing each of the parses;
computing a centroid for each cluster in the initial set of clusters to obtain a plurality of centroids;
computing a distance metric between each of the plurality of samples and each of the centroids; and
repartitioning the plurality of samples so that each sample is placed in the cluster the centroid of which has the lowest distance metric with respect to that sample.

23. The data processing system of claim 21, wherein dividing the plurality of samples into clusters further comprises:
dividing the plurality of samples into an initial set of clusters;
calculating a similarity measure between each pair of clusters in the set of clusters; and
repeatedly combining in a greedy fashion the pair of clusters in the set of clusters that are the most similar according to the similarity measure.

24. The data processing system of claim 21, further comprising:
means for computing pairwise distance metrics for each pair of samples in the plurality of samples;
means for dividing the plurality of samples into groups, wherein each sample in each of the groups has a zero distance metric with respect to other samples in the same group; and
means for replacing each of the groups with a representative sentence from that group.

25. The data processing system of claim 21, wherein the at least one sample is selected on the basis of the at least one sample maximizing an uncertainty measure, wherein the uncertainty measure represents a degree of uncertainty in the parsing model as applied to the at least one sample.

26. The data processing system of claim 25, wherein the uncertainty measure is a change in entropy of the parsing model.

27. The data processing system of claim 26, wherein the plurality of samples include sentences and the change in entropy is normalized with respect to sentence length.

28. The data processing system of claim 25, wherein the uncertainty measure is sentence entropy.

29. The data processing system of claim 28, wherein the plurality of samples include sentences and the sentence entropy is normalized with respect to sentence length.

30. The data processing system of claim 21, wherein the parsing model is represented as a decision tree.
